(19) United States
(12) Patent Application Publication
(10) Pub. No.: US 2012/0161622 A1
(43) Pub. Date: Jun. 28, 2012

(54) High-pressure discharge lamp with starting aid

(75) Inventors: Michael Beau, Berlin (DE); Andreas Hohlfeld, Berlin (DE); Sascha Piltz, Berlin (DE); Karen Twesten, Berlin (DE); Ludger Wilken, Berlin (DE)

(73) Assignee: OSRAM AG, Muenchen (DE)

(21) Appl. No.: 13/329,350

(22) Filed: Dec. 19, 2011

(30) Foreign Application Priority Data
Dec. 23, 2010 (DE) 10 2010 064 040.9

(51) Int. Cl. H01J 61/54; H01J 61/073; H01J 61/18; H01J 61/36

(52) U.S. Cl. 313/623

(57) ABSTRACT

A high-pressure discharge lamp with a starting aid has a discharge vessel, the discharge vessel being held in an outer bulb by means of a frame. A UV enhancer which is fixed directly by means of the frame is used as the starting aid.

### CROSS-REFERENCE TO RELATED APPLICATIONS

The present application claims priority from German application No. 102010064040.9 filed on Dec. 23, 2010, the entire contents of which are incorporated herein by reference.

### TECHNICAL FIELD

The invention is based on a high-pressure discharge lamp, and in particular high-pressure discharge lamps for general lighting.

### BACKGROUND

U.S. Pat. No. 5,811,933 and U.S. Pat. No. 6,919,686 have disclosed a high-pressure discharge lamp with a ceramic discharge vessel, in which a starting aid is used. The starting aid is a so-called UV enhancer with a ceramic vessel, which is fitted separately. The fitting of such separate UV enhancers is complicated and expensive. Similar UV enhancers are previously known from WO 2010/119793 and WO 2010/131574.

### SUMMARY

In one implementation, a high-pressure discharge lamp with a starting aid includes a discharge vessel which is accommodated in an outer bulb, a frame with frame parts holding the discharge vessel in the outer bulb, with a UV enhancer being accommodated in the outer bulb as starting aid, such that the UV enhancer has a UV-transparent container, the container enclosing a cavity which is filled with a gas which can emit UV radiation, and at least one electrode associated with the UV enhancer being formed directly from a section of a frame part.

In another implementation, a high-pressure discharge lamp with a starting aid, includes a discharge vessel which is accommodated in an outer bulb, a frame with frame parts holding the discharge vessel in the outer bulb, with a UV enhancer being accommodated in the outer bulb as starting aid, such that the UV enhancer has a UV-transparent container, the container surrounding a cavity which is filled with a gas which can emit UV radiation, and a section of a bow wire is bent at the level of the UV enhancer in the direction towards the discharge vessel.

One or more of the following features may be included or combined in the above implementations. The high-pressure discharge lamp may be configured such that the vessel of the UV enhancer is manufactured from ceramic and in particular has an electrode which protrudes inwards into the vessel and is manufactured from Nb. The high-pressure discharge lamp may be configured such that the vessel of the UV enhancer is manufactured from quartz glass and in particular has an electrode which protrudes inwards into the vessel and which is manufactured from W or Mo. The high-pressure discharge lamp may be configured such that the vessel of the UV enhancer is designed as a tube with two ends, in particular both ends being sealed by means of glass solder or fused ceramic or a pinch seal. The high-pressure discharge lamp may be configured such that the associated electrode is an inner electrode which is designed in such a way that a section of a frame part is a wire which is surrounded by the vessel. The high-pressure discharge lamp may be configured such that the associated electrode is an inner electrode which is realized by a pin or a film in the cavity of the vessel. The high-pressure discharge lamp may be configured such that the UV enhancer is coupled capacitively to the frame or the electrode system of the discharge vessel. The high-pressure discharge lamp may be configured such that the discharge vessel has a metal halide-containing fill. The high-pressure discharge lamp may be configured such that the container of the UV enhancer is fixed with the aid of a frame part, in particular a wire, and in particular is fastened to the frame part. The high-pressure discharge lamp may be configured such that the container of the UV enhancer is fused directly onto a frame part in the form of a frame wire and in particular in the process the frame wire is shaped in such a way that the UV enhancer bears directly against the wall of the discharge vessel.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a high-pressure discharge lamp with a UV enhancer, schematically;

FIG. 2 shows a further exemplary embodiment of a high-pressure discharge lamp with a UV enhancer (FIG. 2a) and a detail thereof (FIG. 2b);

FIGS. 3 to 7 each show a further exemplary embodiment of a high-pressure discharge lamp with a UV enhancer;

FIG. 8 shows a glass solder ring for use for sealing of a vessel for a UV enhancer, in two views shown in FIGS. 8a and 8b;

FIG. 9 shows a further exemplary embodiment of a UV enhancer.

### DETAILED DESCRIPTION

In the following description, numerous specific details are given to provide a thorough understanding of embodiments. The embodiments can be practiced without one or several specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

Various embodiments provide a high-pressure discharge lamp which can be started reliably without any noticeable increase in costs.

Further embodiments are directed in particular to metal halide lamps, with the material of the discharge vessel being ceramic.

The modified integrated UV enhancer provides some advantages over existing embodiments. It is inexpensive, can be fitted easily and is nevertheless reliable.

Normally, first a separate UV enhancer is produced using a bulb having quartz glass and is then welded to the short power supply line of the frame which holds the discharge vessel. Then, a strip of molybdenum or a thin wire is passed around said UV enhancer and brought together again at the ends in order to enable tight contact. Then, the other end of the strip is welded to the long power supply line of the frame. In comparison with a starting structure without a UV enhancer, three additional welded joints are required here.

The vessel of the enhancer is normally produced from quartz glass or ceramic. A metal film is located in the vessel and acts as an electrode. This electrode is coupled capacitively to another electrode, which is positioned outside the vessel.

The novel UV enhancer which can be produced inexpensively is now integrated with the frame. In particular, its vessel or bulb is manufactured from ceramic such as PCA or else from quartz glass. The vessel is used together with a niobium wire as electrode or with a film of Mo. The niobium wire ends either at the outer surface of the vessel in the sense of an outer electrode or is surrounded in a gas-tight manner by the vessel, preferably by means of a fuse seal.

The integrated UV enhancer is based on the concept of using the frame directly as electrode or component part for capacitive coupling.

The production works best, but not exclusively, in the following way: Push ceramic tube as vessel over the niobium wire of the frame. The tube is preferably a tube with in principle two open ends. Attach first glass solder ring to a first end of the ceramic tube. Perform fuse-sealing analogously to one end of a ceramic discharge vessel. Push second glass solder ring onto a second open end of the ceramic tube. Set desired coldfilling pressure in the ceramic tube by supplying a noble gas or a noble gas mixture; in particular the coldfilling pressure should be between 10 mbar and 300 mbar, using a noble gas, for example argon. Fuse-seal second open end analogously to the fuse-sealing of one end of a ceramic discharge vessel.

Advantageously, a single electrode is located in the cavity. This single electrode is preferably in the form of a metal film having Mo or else W, which is preferably cylindrical, within the cavity. The second electrode is then virtually a dielectrically impeded electrode on the outside. This film is connected to the actual electrode system giving the potential or to a bow wire by a metal wire as contact part.

The volume of the cavity is filled with a suitable gas or Penning mixture (for example Ar, Ar—Xe or Ar—Hg or N₂) and is sealed off, preferably with a glass solder. The filling pressure of the gas (cold) should be between 1 mbar and 100 mbar.

Before the cavity is sealed in the vessel of the UV enhancer, which takes place at best with a glass solder or a fused ceramic, first the actual electrode system of the discharge vessel is introduced using conventional joining technology, for example fuse-sealing of a glass solder.

Separate UV enhancers require installation space in the outer bulb of the lamp, which is critical in particular in the case of relatively small high-pressure discharge lamps, i.e. at wattages of up to 50 W, for example.

Furthermore, the precise positioning of a separate enhancer as close as possible to the capillary is problematic. Manufacturing-related discrepancies in terms of position can influence the effect of the enhancer on the starting response of the lamp.

A virtually integrated UV enhancer as is described here is such that it may have absolute true positioning and a constant effect. The UV generation takes place in the direct vicinity of the discharge vessel.

An embodiment of UV enhancers with two electrodes is also possible, and the installation of further components, such as a capacitor (U.S. Pat. No. 4,987,344) and even more complex drive means (U.S. Pat. No. 4,721,888), for example, is also possible in order to limit the current through the UV enhancer. In general, however, UV enhancers have been utilized which only have one electrode and which use dielectrically impeded discharge. These UV enhancers are relatively inexpensive. The counterelectrode is fitted on the discharge vessel from the outside in the sense of capacitive coupling.

An example of a suitable electrode is a metal wire having Nb, which reaches into the vessel of the enhancer. This inner electrode is connected to the actual electrode system giving the potential or the bow wire. The other exemplary embodiment of a suitable electrode form is a metal film having Mo or W, which is located inside the cavity and which is connected to the actual potential-giving electrode system or bow wire or else long power supply line by a metal wire. In this case, the vessel of the UV enhancer is manufactured from quartz glass.

A metal film or one to two wires which are located outside the enhancer is/are in contact with the opposing terminal and acts as second electrode.

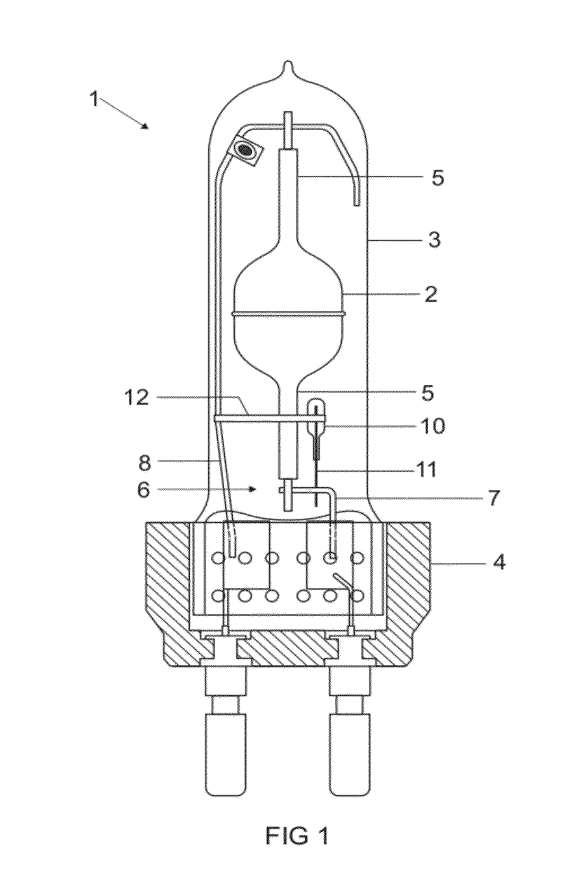

FIG. 1 shows a schematic of a metal halide lamp 1, in which a discharge vessel 2 having PCA is contained in an outer bulb 3 having quartz glass, which is sealed off by a base 4. The discharge vessel 2 has two ends at which capillaries 5 are positioned.

The discharge vessel 2 is provided with a metal halide fill, as is known per se. Said discharge vessel is held in the outer bulb 3 by means of a frame 6, which has a short frame wire 7 and a long bow wire 8. A UV enhancer 10 with a quartz glass vessel which is connected to the short frame wire 7 having Nb via a feedline 11 having Nb is positioned in the vicinity of a first capillary 5. A metallic strip 12, usually having Mo, surrounds the vessel and ends at the bow wire 8.

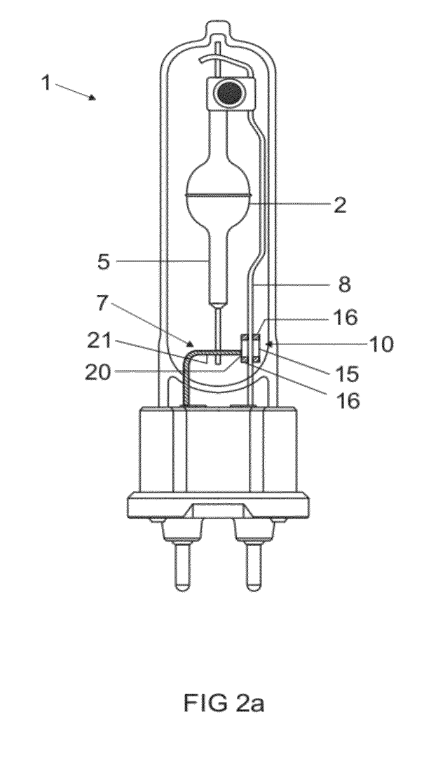

Such UV enhancers 10 need to be coupled capacitively to opposing potential, or contact needs to be made between the two, in order to enable dielectrically impeded discharge. For this purpose, the short frame wire 7, which is manufactured from Nb, can be extended and led up to the ceramic vessel of the UV enhancer (see FIG. 2). In the process, the bow wire 8 having Nb is passed through the sleeve 15 of the vessel of the UV enhancer 10. Both open ends of the sleeve 15 are then sealed off with glass solder 16. The short power supply line 7 is bent back toward the side of the sleeve 15. The free end 20 of the short power supply line ends directly at the outer surface of the sleeve. Preferably, the short power supply line 7 is bent back at right angles, and the UV enhancer 10 is positioned straight, approximately at the level of the bent-back branch 21 of the short power supply line, directly on the bow wire 8.

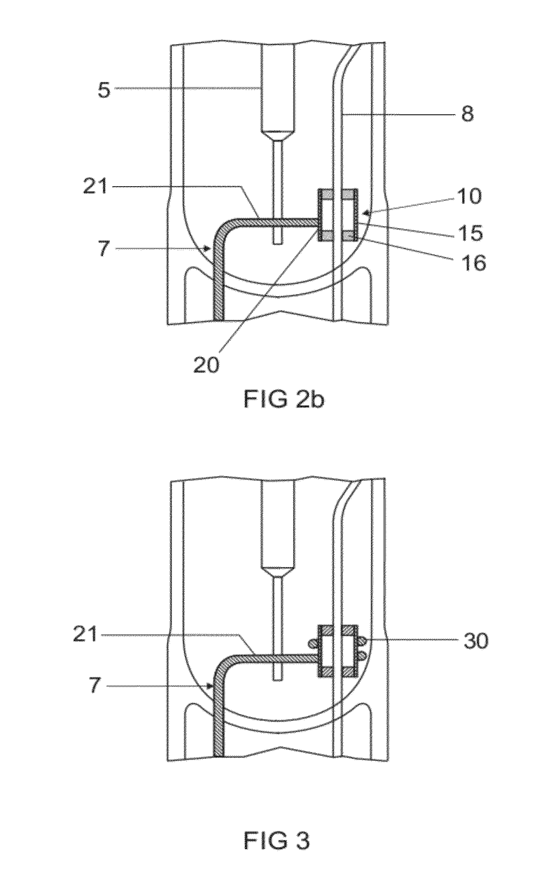

A further exemplary embodiment for making contact with the opposing potential is, as the end of the short frame wire 7, a filament 30, which is attached to the truncated free end 20 of the short power supply line 7 and is wound around the vessel of the UV enhancer 10 (see FIG. 3). Preferably, the filament 30 is wound at least twice, in particular at most three times.

Alternatively, a film can also be used instead of the filament, said film being wrapped around the UV enhancer as a strip (see FIG. 1). The advantage is that, in contrast to the prior art, it is possible to dispense with three welded joints and the UV enhancer only requires a small installation space. The prior art (FIG. 1) requires three additional welded joints, in contrast to fitting without a UV enhancer: the UV enhancer needs to be welded to the frame, the film needs to be welded together, and the film needs to be welded to the frame. The present design does not require any of these three welded joints.

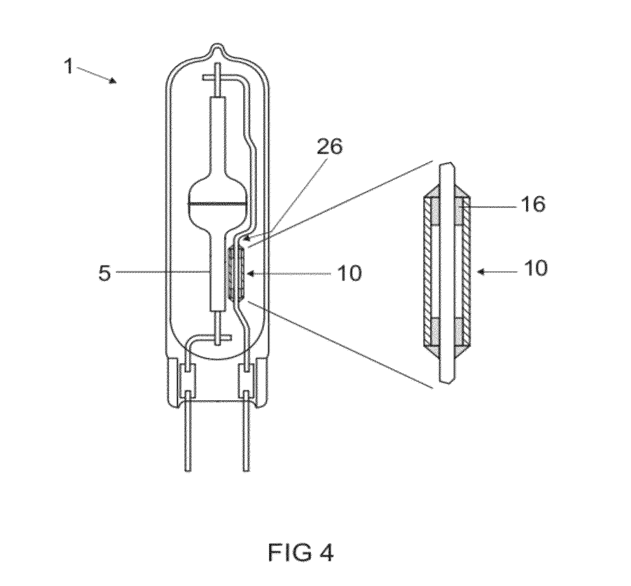

FIG. 4 shows a further exemplary embodiment. In this case, analogously to FIGS. 2 and 3, the UV enhancer 10 is fused to the long power supply line, the bow wire 8. However, in this case the bow wire 8 is bent (26) in such a way that the UV enhancer touches the first capillary 5 or at least comes close to said capillary on the outside. Since in this case the opposing potential is not applied directly, but is only available in the interior of the capillary 5, in this exemplary embodiment the UV enhancer should be filled with a Penning mixture of Ne/Ar or Ar/Xe.

Preferably, in all of the examples the UV enhancer is first produced by a tube or sleeve being pushed onto the still straight bow wire 8 and then filled and sealed by means of glass solder. Only then is the bow wire 8 bent, as illustrated in FIG. 4.

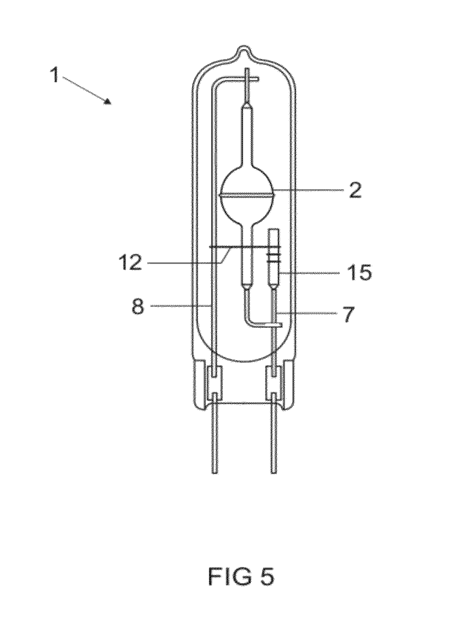

A further exemplary embodiment is shown in FIG. 5. In this case, the ceramic UV enhancer 10 is manufactured analogously to points 1) to 6) of the production method, with the difference that the end of the short frame wire 7, a niobium wire, is not passed through the UV enhancer 10, but only protrudes as far as into the vessel, i.e. into the interior of the sleeve 15. The short power supply line 7 of the discharge vessel is used directly as electrode of the UV enhancer and thus simplifies fitting considerably. In comparison with the prior art, at least one welded joint is thus dispensed with.

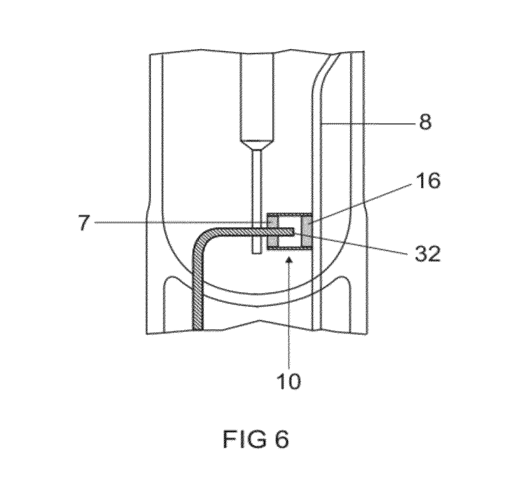

A further possibility is shown in FIG. 6. As in FIG. 5, the UV enhancer 10 is manufactured with contact being made on the one side. The end of the short power supply line 7 of the discharge vessel is used as electrode 32 of the UV enhancer and is inserted into the first end of the vessel of the UV enhancer (see FIG. 6). The first end is then sealed with glass solder 16. The second end of the vessel of the UV enhancer is attached to the bow wire 8 and can thus produce the voltage for generating the UV radiation in the case of starting.

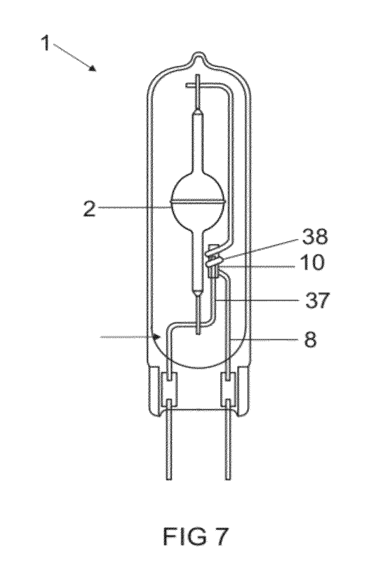

FIG. 7 shows a further possibility for simple fitting of the UV enhancer 10. As in FIG. 6, the UV enhancer with which contact is made on one side is formed by the end of the short power supply line 7. This end 37 is, however, bent back in such a way that it is oriented parallel to the discharge vessel 2. The bow wire 8 is bent back at the level of the UV enhancer 10 and is passed around said UV enhancer as a filament 38.

In the case of all the exemplary embodiments, care needs to be taken to ensure that the metallic power supply lines 7, 8 do not come too close to one another. This is necessary in order to prevent discharge in the outer bulb. A typical minimum distance is 3 mm.

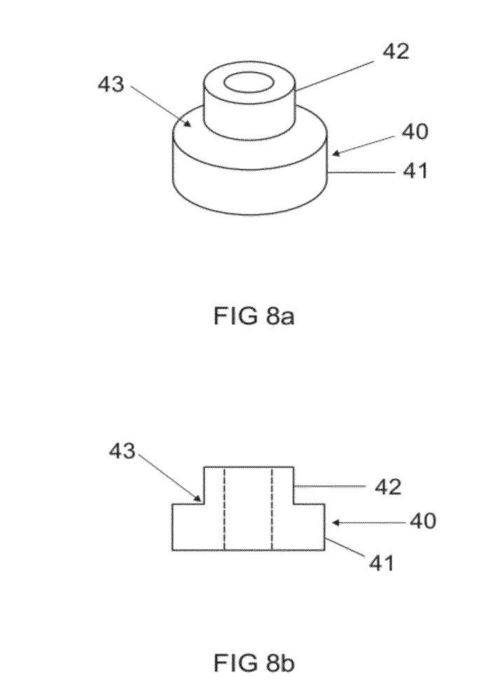

Preferably, a step-shaped glass solder ring 40 can be used for these examples of a UV enhancer for sealing the ends of the ceramic sleeve 15. Said glass solder ring is configured with a relatively large circular ring 41 and a concentric relatively small circular ring 42 attached thereto, with the result that it can be inserted better into the ceramic tube or sleeve 15 of the vessel and does not slide so easily during processing. FIGS. 8a and 8b illustrate such a glass solder ring 40. The prior art does not have this step 43.

The present examples are suitable for frame wires having niobium. The coefficient of linear thermal expansion of niobium (7.9×10⁻⁶) applies very well to that of the ceramic vessel of the UV enhancer having PCA (8.1×10⁻⁶). Analogously to the fuse-sealing of the discharge vessel, this material combination can withstand many thermal cycles of switch-on and switch-off operations.

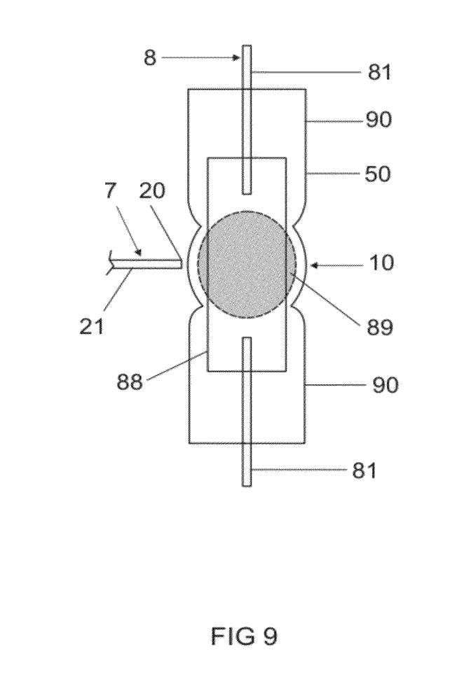

In a further exemplary embodiment as shown in FIG. 9, the tubular vessel 50 of the UV enhancer is manufactured from quartz glass. In this case, that part of the frame which is adjacent to the UV enhancer, for example a section of the bow wire 8, should be manufactured from molybdenum (5.8×10⁻⁶). The embodiments similar to those shown in FIGS. 2 to 7 are thus possible.

The manufacture is in this case performed as follows:
1) Welding in each case one Mo wire 81 to each side of a molybdenum film 88. Said Mo wires then together form the long power supply line, i.e. the bow wire 8 (see FIG. 2a or 4).
2) Then, a quartz glass tube is pushed over this, said quartz glass tube protruding behind the Mo film 88 on both sides by a few millimeters.
3) Finally, the quartz glass tube is pinch-sealed (90) at the first end of the UV enhancer in order to seal off said UV enhancer.
4) Setting the desired coldfilling pressure between 10 mbar and 300 mbar, with the fill being a noble gas, for example Ar.
5) Producing the second pinch seal 90 analogously to step 3).

FIG. 9 shows a sketch of such a UV enhancer 10, with the power supply lines 81 having molybdenum which protrude into the tube 50 and are connected to one another in the center via a molybdenum film 88. The cavity 89 in the center, which is bridged by the film 88, is surrounded by the quartz glass tube 50, with the result that a dielectrically impeded discharge, relative to the short frame wire 7, can take place in the cavity. In this case, the outer electrode which passes close by is, for example, the free end 20 of the short frame wire.

Fitting is performed analogously to FIG. 2, 3 or 4, for example. The exemplary embodiments in FIGS. 5, 6 and 7 can also be realized with a UV enhancer having quartz glass with which contact is made on one side in accordance with the prior art.

What is claimed is:

1. A high-pressure discharge lamp with a starting aid, having a discharge vessel which is accommodated in an outer bulb, a frame with frame parts holding the discharge vessel in the outer bulb, with a UV enhancer being accommodated in the outer bulb as starting aid, wherein the UV enhancer has a UV-transparent container, the container enclosing a cavity which is filled with a gas which can emit UV radiation, and at least one electrode associated with the UV enhancer being formed directly from a section of a frame part.

2. The high-pressure discharge lamp as claimed in claim 1, wherein the vessel of the UV enhancer is manufactured from ceramic and has an electrode which protrudes inwards into the vessel and is manufactured from Nb.

3. The high-pressure discharge lamp as claimed in claim 1, wherein the vessel of the UV enhancer is manufactured from quartz glass and has an electrode which protrudes inwards into the vessel and which is manufactured from W or Mo.

4. The high-pressure discharge lamp as claimed in claim 1, wherein that vessel of the UV enhancer is designed as a tube with two ends, and both ends being sealed by means from the group consisting of: glass solder, fused ceramic, and a pinch seal.

5. The high-pressure discharge lamp as claimed in claim 1, wherein the associated electrode is an inner electrode which is designed in such a way that a section of a frame part is a wire which is surrounded by the vessel.

6. The high-pressure discharge lamp as claimed in claim 1, wherein the associated electrode is an inner electrode which is realized by a pin or a film in the cavity of the vessel.

7. The high-pressure discharge lamp as claimed in claim 1, wherein the UV enhancer is coupled capacitively to the frame or the electrode system of the discharge vessel.

8. The high-pressure discharge lamp as claimed in claim 1, wherein the discharge vessel has a metal halide-containing fill.

9. The high-pressure discharge lamp as claimed in claim 1, wherein the container of the UV enhancer is fixed with the aid of a frame part and is fastened to the frame part.

10. The high-pressure discharge lamp as claimed in claim 9, wherein the frame part is a wire.

11. The high-pressure discharge lamp as claimed in claim 9, wherein UV enhancer is fastened to the frame part.

12. The high-pressure discharge lamp as claimed in claim 1, wherein the container of the UV enhancer is fused directly onto a frame part in the form of a frame wire and in the process the frame wire is shaped in such a way that the UV enhancer bears directly against the wall of the discharge vessel.

13. A high-pressure discharge lamp with a starting aid, having a discharge vessel which is accommodated in an outer bulb, a frame with frame parts holding the discharge vessel in the outer bulb, with a UV enhancer being accommodated in the outer bulb as starting aid, wherein the UV enhancer has a UV-transparent container, the container surrounding a cavity which is filled with a gas which can emit UV radiation, and a section of a bow wire is bent at the level of the UV enhancer in the direction towards the discharge vessel.
